(19) United States
(12) Patent Application Publication
(10) Pub. No.: US 2010/0031803 A1
(43) Pub. Date: Feb. 11, 2010

(54) TACTILE OR HAPTIC DEVICE, AND A MUSICAL KEYBOARD WITH AT LEAST ONE SUCH SIMULATION DEVICE

(75) Inventors: Jose Lozada, Fresnes (FR); Xavier Boutillon, Antony (FR); Moustapha Hafez, Paris (FR)

Correspondence Address: Nixon Peabody LLP, P.O. Box 60610, Palo Alto, CA, 94306, US

(73) Assignee: Commissariat A L'Energie Atomique, Paris (FR)

(21) Appl. No.: 12/304,748

(22) PCT Filed: Jun. 12, 2007
(86) PCT No.: PCT/EP07/55769

§ 371 Date: Oct. 15, 2009

(30) Foreign Application Priority Data
Jun. 14, 2006 (FR) 06 52160

(51) Int. Cl. G10C 3/12; G10H 1/34

(52) U.S. Cl. 84/439; 84/452 R; 84/442; 84/423 R

(57) ABSTRACT

A tactile or haptic sensation simulation device designed to oppose the movement of a manual control component with a reaction reflecting the movement of the control, where the said device has a chamber containing a magneto-rheological fluid, a mobile element interacting mechanically with the fluid and intended to be linked mechanically to the control component, where the said element is mobile between two predetermined positions, at least one sensor with a cinematic and/or dynamic range that is representative of the movement of the control component, a control component and means for the generation of a suitable magnetic field around the chamber so as to apply a magnetic field that is dependent on the dynamic characteristics to be simulated for the movement of the manual control component, and the real-time measurements, the whole being such that the apparent viscosity of the magneto-rheological fluid varies over the travel of the manual control component.

This application is a national phase of International Application No. PCT/EP2007/055769, entitled “TACTILE OR HAPTIC SIMULATION DEVICE AND MUSICAL KEYBOARD INCLUDING AT LEAST A SIMILAR SIMULATION DEVICE”, which was filed on Jun. 12, 2007, and which claims priority of French Patent Application No. 06 52130, filed Jun. 14, 2006.

### DESCRIPTION

### Technical Field and Prior Art

This present invention relates to a tactile or haptic device to oppose the advance of a manual control component with a reaction reflecting the movement of the control, where the said device uses a magneto-rheological fluid as the means for generating a reaction by the modulation of a magnetic field.

This device can be used in particular to control the force presented by the keys of a musical keyboard, or the movement of the keys, in order to improve the sensation of the musician.

In fact, feel is the main weakness of the keyboards of digital instruments in relation to traditional keyboards, and in particular those of pianos. With the aim of rendering the keyboards of chromatic digital musical instruments with twelve keys per octave more attractive from a sensory viewpoint, many technological developments have appeared in recent years.

There exist so-called passive systems used to improve the touch sensation, described in particular by documents US2004/0065186A1 and US2005/0011330A1. These systems use a calibrated hammer with a complicated movement, which has the effect of increasing the resistance of the key to the movement by increasing the total inertia of the system. Document US2003/0131720A1 also describes a passive force feedback system coupled to a sound-generating system that uses the information from several sensors in order to render the latter closer to the touch recorded.

We are also familiar with so-called active systems that employ electromagnetic actions. These active systems use linear or rotary electromagnetic actions to monitor the force necessary to press down the key, and this type of system is described in documents U.S. Pat. No. 5,783,765 and U.S. Pat. No. 5,977,466, for example.

Given the complexity of the action system of the keys in a traditional piano, in particular of a concert grand, electromagnetic actuators are unable to reproduce all of physical phenomena that occur during movement of the key. Moreover, the response time, the force range and the amplitude of movement necessary, render the electromagnetic action inadequate to satisfy the needs of the application. Finally, the electromagnetic actuators are liable, by their nature, to communicate energy to the system and therefore to generate vibratory instabilities that the control scheme must be designed to eliminate.

We are also aware, from document U.S. Pat. No. 5,409,435, of a muscle-building appliance with a device opposing the movement of a cable, whose force is adjustable, with a reaction that is identical to the normally-felt continuous reaction generated by lifting a weight.

The appliance comprises a vessel containing a magneto-rheological fluid, a disk designed to turn on its own axis under the action of a cable moved by a user, and a source of magnetic field to modify the apparent viscosity of the magneto-rheological fluid.

The muscle-building appliance also comprises sensors of the force applied to the cable and/or of the movement of the cable, with these data used to modulate the magnetic field.

Thus, the speed of movement in continuous rotation of the disk around its axis is modified by modifying the apparent viscosity of the magneto-rheological fluid, simulating a load applied to the cable.

This type of device has the drawback of being complex to manufacture and very bulky.

It is therefore not suitable for miniaturisation and for application in systems of small size, such as the keys in the keyboard of a digital musical instrument.

In addition, the exercise appliance is neither sufficiently rapid nor designed to be transposed to systems in which the required reaction must be variable rapidly, meaning in the time scale that is characteristic of the movement, and felt virtually instantaneously, in order to allow effective control of the latter, in the case in which one wishes to simulate sensation when pressing the key of a piano for example.

Moreover, the exercise appliance of the prior art does not provide a sufficient sensitivity for high-precision systems, such as the chromatic musical keyboards with twelve keys per octave.

As a consequence, it is one aim of this present invention to provide a tactile or haptic sensation simulator that is easy to implement.

It is also an aim of this present invention to provide a tactile or haptic sensation simulator of small size.

It is another aim of this present invention to provide a tactile or haptic sensation simulator that is highly responsive and of great sensitivity.

It is finally an aim of this present invention to provide a tactile or haptic sensation simulator in which the main control loop is intrinsically stable in relation to vibration.

### Presentation of the Invention

The aforementioned aims are attained by a tactile or haptic simulator of sensation in response to the operation of a manual control component, using a magneto-rheological fluid that is subjected to a suitable magnetic field, in order to control the force necessary for the movement, or the movement itself, of the control component, such as a key on an electrical musical keyboard for example.

The magneto-rheological fluid comprises micro-particles in suspension, which react under the action of a magnetic field and cause the apparent viscosity of the fluid to vary.

The response time is then of the order of one millisecond. The device according to the invention does not exhibit any limitation of the amplitude of the movement associated with the fluid, with the amplitude of movement then being determined by the device. In addition, the device according to the invention is used to cause the resisting force to vary to very high values, given a suitable magnetic field.

According to this present invention, the simulator comprises a chamber containing a magneto-rheological fluid, at least one element that is intended to be linked mechanically to the manual control component, and mobile between first and second predetermined positions, with the said element interacting with the magneto-rheological fluid, at least one sensor with a high cinematic or dynamic range that is representative of the movement of this element or of the control component, with this sensor being linked to a control component, which itself is linked to a magnetic field generator.

In other words, the simulator comprises an element that is interacting with the magneto-rheological fluid, and mobile between two predetermined positions, with these two positions determining the extreme operating positions of the control component. During the passage from one position to the other, the apparent viscosity of the magneto-rheological fluid is modified by the magnetic field, which itself is controlled in real time in accordance with the cinematic and/or dynamic magnitudes representing the movement of the control component.

The simulator of this present invention is of simple design and of small size, which renders it particularly suitable for the keys on a musical keyboard. Its small size allows its installation below or above a key. In addition, it provides a high response speed and high reaction sensitivity by virtue of the properties of the magneto-rheological fluid. In addition, the cinematic chain between the control component and the mobile element interacting with the magneto-rheological fluid is reduced. The simulated reaction is then very close to that felt in the case of a conventional traditional piano.

The exercise appliance described by document U.S. Pat. No. 5,409,435 presents the operator, during his or her movement, with a more-or-less constant force, of which the value (“Vref”) is adjustable by a command external to the appliance at a given level (the “threshold value”). By contrast, the simulator of this present invention presents the operator with a force that is automatically variable during the period of movement between the two positions, simulating, in real time, the dynamic operation of a third-party device (a traditional musical keyboard for example) of which the dynamic model is incorporated explicitly into the control component.

Firstly, the control scheme of the magnetic field of the exercise appliance described by document U.S. Pat. No. 5,409,435 does not provide for this calculation of the magnetic field in real time, and therefore of the force supplied according to a predetermined scheme, and secondly, the cinematic chain between the operator and the controlled component (shown in FIGS. 6 to 10) comprises too many flexible intermediate mechanical elements to allow precise control of a rapidly variable force presented to the operator. This present invention, which comprises a semi-rigid link between the control component and the controlled component (a mobile element interacting with the magneto-rheological fluid) and replacing the reference level of the force (“Vref”) by a dynamic internal model, renders possible the control of the force with a time constant of the order of one millisecond, with a precision of the order one tenth of a Newton.

The main subject-matter of this present invention is therefore a tactile or haptic sensation simulation device to present the movement of a manual control component with a reaction that reflects the operation of the control, where the said device comprises a chamber containing a magneto-rheological fluid, a mobile element interacting mechanically with the fluid, formed by a mobile blade interacting with the magneto-rheological fluid and designed to shear the said fluid, and intended to be linked mechanically to the control component, with the said element being mobile between two predetermined positions, at least one sensor with a high cinematic or dynamic range that is representative of the movement of this element or of the control component, and a control component with means to generate a suitable magnetic field around the chamber, with the said sensor being linked to the control component, which itself is linked to the means for generating a magnetic field, the whole being such that the apparent viscosity of the magneto-rheological fluid varies during movement of the manual control component.

The control component is designed to receive, in real time, measurements coming from at least one sensor, and to calculate the current to be applied to the means for generating the magnetic field as a function of time, firstly from a dynamic model of the device to be simulated, and secondly from the real-time measurements coming from at least one sensor.

The sensor can be chosen from between a force sensor applied to or by the manual control component or a sensor of the movement of the manual control component or the mobile element.

According to the invention, the mobile element is a blade designed to shear the magneto-rheological fluid.

The blade can advantageously be flexible, when the movement of the mobile element is then facilitated and the device is rendered more robust.

The simulation device can then comprise a blade support with a resistance to buckling that is greater than that of the blade, and which is designed to connect the blade to the manual control component, which eliminates the risk that the blade may buckle.

The blade can be in a nonmagnetic material, such as brass, copper or mica for example. Alternatively, the blade can be in a magnetic material, such as iron or steel, in which case guidance means, made from a nonmagnetic material, are advantageously provided.

According to the invention, the chamber comprises a flexible pocket containing a magneto-rheological fluid, with the said pocket being sandwiched between one pole of the means for generating the magnetic field and the blade, and with the said blade being in more-or-less flat contact with an outer envelope of the pocket.

In one variant of achievement, the chamber comprises several flexible pockets containing a magneto-rheological fluid, the said pockets being sandwiched between one pole of the means for generating the magnetic field and the blade, and with the said blade being in more-or-less flat contact with the outer envelopes of the pockets.

According to a variant of the invention, the blade penetrates into the magneto-rheological fluid.

In this variant of achievement, the blade support can comprise a rod in two parts, a first part positioned in the chamber, and a second part positioned outside the chamber, with a flexible membrane closing off one end of the chamber in a sealed manner being pinched between the two parts of the rod.

The simulation device can comprise means for returning the manual control component to the rest position.

In addition, the means for generating a variable magnetic field comprise at least one electrical solenoid.

According to an variant of achievement of the invention, the chamber can advantageously be bordered laterally and directly by the means for generating the magnetic field and plates or shells, where the magneto-rheological fluid comes into direct contact with the means for generating the magnetic field, and in which the chamber is bordered longitudinally at a first end by a flexible membrane, and/or at a second end by a cap or by a flexible membrane.

The chamber can also be bordered laterally and directly by an element added as a single part, with lateral openings closed off by the poles of the means for generating the magnetic field, where the magneto-rheological fluid comes into direct contact with the means for generating the magnetic field, and in which the chamber is bordered longitudinally at a first end by a flexible membrane, and/or at a second end by a cap or by a flexible membrane.

The subject-matter of the present invention is also a manual control system, with at least one manual control component, and at least one simulation device of this present invention, associated with the said control component.

This present invention also has as its subject a chromatic musical keyboard equipped with twelve keys per octave and a simulation device of this present invention associated with each key.

In the descriptions that follow, the simulator of this present invention is associated with a key of a musical keyboard, in order to exert on the finger of the musician an action that is similar, in a sensory sense, to that which would be exerted by a traditional keyboard, of a piano for example, by simulating the dynamic behaviour of a traditional keyboard key, of a piano for example, when the musician presses down on the keys. However, this present invention applies to any device in which it is desired to artificially reproduce a sensation in response to a force exerted on a manual control component.

The term “manual control component” is not limited to an element that is operated using the hand or the finger, but in fact refers to any element that can be operated with any other part of the body, like the foot, when the manual control component can then be a pedal.

### BRIEF DESCRIPTION OF THE DRAWINGS

This present invention will be understood more clearly on reading the description that follows with reference to the appended drawings, in which the left and the right, the top and the bottom correspond respectively to the left and right parts, and the top and bottom parts of the drawings, in which:

FIG. 1 is a diagrammatic side view, with a partial section, of one embodiment of a simulation device of this present invention,

FIG. 2 is a detail of the device of FIG. 1,

FIG. 3 is a view in perspective of an implementation variant of the invention,

FIG. 4 is a front view of the device of FIG. 3,

FIG. 5 is a detailed view of one end of the device of FIG. 3,

FIG. 6 is a detailed view of another end of the device of FIG. 3,

FIG. 7 is a top view of the device of FIG. 3,

FIGS. 8A and 8B are views in perspective of a second example of the achievement of a chamber containing the magneto-rheological fluid,

FIGS. 9A to 9C represent an example of a system for the guidance, by the top (9B) and by the bottom (9C) of the blade (9A) of the second embodiment,

FIG. 10 represents a rotating slider crank mechanism implemented in the second example of achievement of the chamber containing the magneto-rheological fluid,

FIG. 11 represents a block diagram of all the elements of the simulator and of its environment.

### DETAILED PRESENTATION OF PARTICULAR EMBODIMENTS

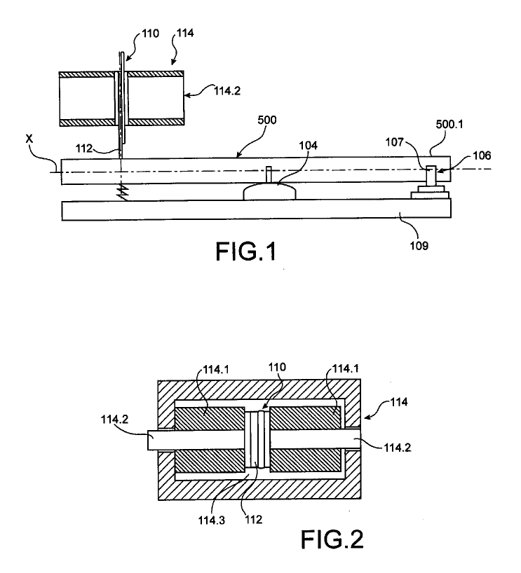

In FIGS. 1 and 2, we can see a first embodiment of a simulator of this present invention with a pocket (110) containing a magneto-rheological fluid, and a mobile blade (112) in shear interaction with the magneto-rheological fluid.

In this present application, the term “blade” refers to an element with a length and a width that are very large in relation to its thickness thus providing a large area that is designed to shear the magneto-rheological while still presenting little strength in its cross section to movement due to a small thickness.

The simulator according to the invention also comprises means (114) for the generation of a magnetic field placed around a zone of the pocket (110) containing the magneto-rheological fluid.

These means (114) comprise a magnetic circuit (114.1) for example, on which are positioned one or more solenoids (114.2), placed on either side of the zone in which the mobile element (112) is in shear interaction with the magneto-rheological fluid.

Thus, when the solenoid or solenoids (114.2) are powered, the latter generate a magnetic field in the zone that they are surrounding, and the ferromagnetic particles contained in this zone tend to align themselves in the direction of the field, causing a variation in the apparent viscosity of the fluid in the active volume, so that the shearing movement of the mobile blade in relation to the magneto-rheological fluid is then braked to a variable extent.

The blade moves along an axial direction contained in the mean plane of the latter.

Means for the electrical powering (not shown) of the electromagnet and of the solenoids are also provided.

The combination of a device using the magneto-rheological fluids and electromagnetic actuation has the advantage of compensating for the initial viscosity of the fluid, and thus of increasing the bandwidth of resisting force in the zone of low resistance. This combination provides an improvement in the real-time control of the feed current and therefore of the resisting force supplied by the system.

Thus, it is possible to reproduce the effects of different mechanical phenomena occurring over the travel of a traditional keyboard key, of a piano for example.

A sensor or sensors with a cinematic or dynamic width representing the movement of the mobile element or of the manual control component are also provided. A single sensor can be sufficient, as well as the prior determination of a model. A second sensor can be useful for improving the accuracy of the simulation. The sensor or sensors can be placed directly on the key.

From the temporal measurements effected by the sensor or sensors and one or more analogue-digital converters, a control component (700) (FIG. 11) determines, in real time, the amplitude of the electric current, allowing the means (14) to generate a magnetic field that is suitable for the reaction force to be applied to the key. The calculation of the magnetic field is effected using the data from the sensors and from a mathematical model of the dynamic behaviour to be simulated, which is pre-recorded in the memory of the control component.

In FIG. 11, we can see a diagram of a simulation device representing the interaction between the manual control component shown with the reference 500, the simulator shown with the reference 600, and the control component shown as 700.

As indicated above, the simulator (600) comprises a mobile element (112) designed to shear the magneto-rheological fluid, a force and/or movement sensor (610), and the means to generate a magnetic field (14).

The control component (700) comprises a real-time computer (710), typically a microprocessor of the digital signal processor (DSP) or other type, equipped with one or more analogue-digital converters and with a memory, which determine the electric current to be applied, by means of a digital-analogue converter and possibly a power amplifier (720), to the means for generating the magnetic field, on the basis of dynamic models of mechanical behaviour stored in the computer (710).

The control component can also comprise a power amplifier (720).

We will now explain, in a general manner, the operation of the simulator of this present invention on the basis of the diagram of FIG. 11.

During the operation of the manual control component (500), the mobile element (112) of the simulator (600) is moved, the sensor (610) then measures the variation with time of at least one characteristic physical width of this movement, the temporal measured flow is transmitted to the computer (710) of the control component (700). In real time, the latter determines the temporal succession of the amplitude values of the current that it sends to the means for generating the magnetic field of the simulator (600) via the power amplifier (720) where appropriate. The apparent viscosity of the magneto-rheological fluid then varies during the operation, and a reaction is then transmitted to the control component via the mobile element (112).

We will now explain the specific operation of the device shown in FIGS. 1 and 2.

When the musician presses down on a key that forms the control component, he or she imparts a movement to the blade (112), which moves, shearing the magneto-rheological fluid.

The movement of the key, as well as the force applied to the key, are measured by the sensor during the action of the musician (typically at a sampling frequency of 2 kHz) and transferred to the control component, which determines (typically at a sampling frequency of 2 kHz, though the two sampling frequencies are not necessarily the same) the value of the magnetic field to be applied, and generates the corresponding current in the means (14) for the generation of a magnetic field.

The fluid, under the action of the magnetic field, experiences variation of its apparent viscosity, which renders the movement of the blade (112), designed to shear the magneto-rheological fluid, more difficult or less difficult. The force necessary for the movement is thus controlled in accordance with the model to be simulated, and the desired reaction is then felt by the musician.

When the musician ceases to exert a force on the key, which is detected by the aforementioned sensors, the electromagnet is activated. In an advantageous manner, zero magnetic induction is applied by the control component to the magneto-rheological fluid in this return phase, in order to achieve a rapid flow of the fluid and a rapid return to the rest position. In fact, in the absence of electric current in the solenoids, a remanent magnetic induction nevertheless exists in the magnetic circuit, which needs to be minimised by the application of an electric current corresponding to the coercive field.

The mobile blade (112) is then attracted downwards under the traction of the return spring, which causes the return of the key to the rest position.

This simulator has a high responsiveness due to the small reaction time of the magneto-rheological fluid, and of the cinematic chain that exists between the key and the blade (112). In addition, the simulated reaction can be very precise, and very close to a reaction felt on a traditional piano, by virtue of the calculation in real time of the mechanical resistance felt by the musician according to the predetermined model of a traditional piano. This simulator has the advantage of being very compact, which facilitates its incorporation below the key of a piano. This simulator then becomes very discreet.

We will now describe in detail the simulator of FIGS. 1 and 2. We can see a first embodiment of a tactile or haptic sensation simulator of this present invention, applied to a keyboard-type musical instrument.

We can see a control component (500) formed by a key of a traditional musical keyboard on longitudinal axis X, mounted so that it rotates around a pivot (104) more-or-less at its median part. It could be replaced by a lever pivoting around a fixed point.

A guidance means (106) is provided at one end (500.1) of the key (500) subjected to the force of the musician. The latter is more-or-less the same as that of a piano of the prior art.

The simulator of this present invention comprises a flexible pocket (110) filled with magneto-rheological fluid, means (114) for the generation of a magnetic field, so as to vary the apparent viscosity of the magneto-rheological fluid.

In the example shown, the means (114) comprise two coaxial solenoids (114.1) with a distance between them, a magnetic core (114.2) forming an air gap (114.3) between the solenoids in which the pocket (110) and the mobile element (112) are located, with the whole forming a magnetic circuit channelling the magnetic field.

The pocket (110) is of small thickness in relation to its length and its width. The latter is sandwiched in an air gap of the magnetic circuit, between a mobile element (112) attached to the movement of the key (500) and one of the poles (114.2.1) of the core.

The element (112) of extended shape, on axis Y which is more-or-less orthogonal to axis X of the key (500). In an advantageous manner, the element (112) is formed by a blade, of which a larger area is in more-or-less flat contact with a larger area of the pocket (110).

In a very advantageous manner, the blade (112) is flexible, and is used to absorb the lateral deformations when a force is applied to the key (500).

The blade (112) can be made from nonmagnetic material, of brass for example, or of copper or mica.

Thus, a movement of the blade along its axis Y causes shearing of the fluid contained in the pocket (110).

By application of a variable magnetic field, the apparent viscosity of the fluid is controlled, as is the force necessary for the shearing effect and the resistance to the movement of the blade (112). As a consequence, the reaction felt by the musician during the movement of the key (500) exhibits characteristics of the predetermined model.

Force and movement sensors (not shown) are also provided in order to determine the movement, the speed and the acceleration of the key, as well as the force applied to the key.

These sensors can be placed directly on the key or between the key and the blade (112).

These sensors are linked to a control unit (700) (FIG. 11) that generates, in real time, a variable electric current allowing the means (114) to produce a suitable magnetic field. The calculation of the magnetic field is achieved from the temporal measurements of the sensors and using a mathematical model of the dynamic behaviour to be simulated, and pre-recorded in the memory of the control component.

Return means (116) are also provided between the key and the table (109) so as to return the key to the rest position. The latter are placed more-or-less facing the blade (112) for example, on the other side from the face of the key on which the blade (112) is fixed.

In the example shown, the return means (116) are driven by a spring. It is possible, however, to replace the spring with an electromagnetic actuator element.

In the example shown, the key, the pivot, and the guidance means are those of a traditional piano, but it is possible to replace these with any means that perform the same functions.

For example, the pivot could be formed by an axis passing through a bore made in the key, perpendicular to X axis of the key (500).

By way of illustration, the magnetic circuit can have the following dimensions:
length: 60 mm,
width: 30 mm,
height: 50 mm.

The blade can have a length of 70 mm, and the solenoids can comprise 1000 turns of wire with a diameter 0.25 mm.

We will now explain the operation of the device of this present invention.

The operation described above in relation to FIG. 11 applies here.

When the musician presses down on the key (500), the force applied to the key and/or the movement of the key are measured and transmitted to the control unit, typically at a sampling frequency of 2 kHz.

In accordance with these measurements and of the dynamic model of the device to be simulated, the control unit determines, in real time, the magnetic field to be applied, and generates the appropriate current in the means (114) for the generation of a magnetic field.

The fluid then experiences a change in its apparent viscosity, the shearing of the fluid caused by the movement of the blade (112) is then rendered more difficult or less difficult. A variable resistance, simulating the sensation of a traditional keyboard, of a piano for example, is thus felt by the musician throughout the action of pressing the key.

When the musician releases the pressure on the key, the latter is brought back into the rest position by the return means (116). Zero magnetic induction is then applied to the magneto-rheological fluid, so as to minimise its apparent viscosity and to facilitate the flow in response to the blade in its rest position.

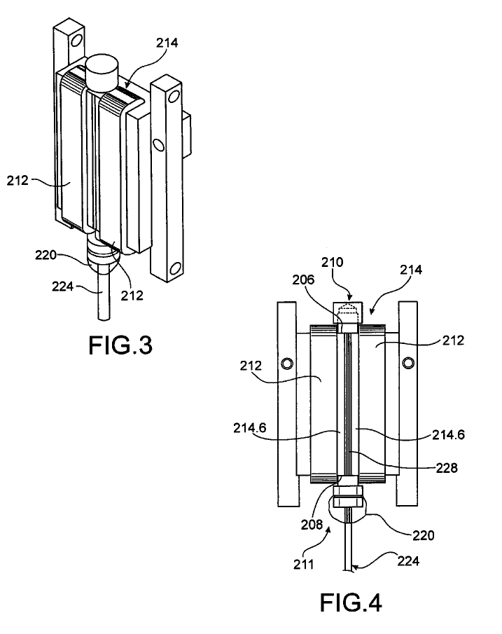

FIGS. 3 to 8 show an implementation variant of a simulation device of this present invention, in which the magneto-rheological fluid is also subjected to a shear stress.

The device of this present invention comprises means (214) to generate a magnetic field in a given space (201) and a chamber (202) filled with magneto-rheological fluid, positioned in the said space (201).

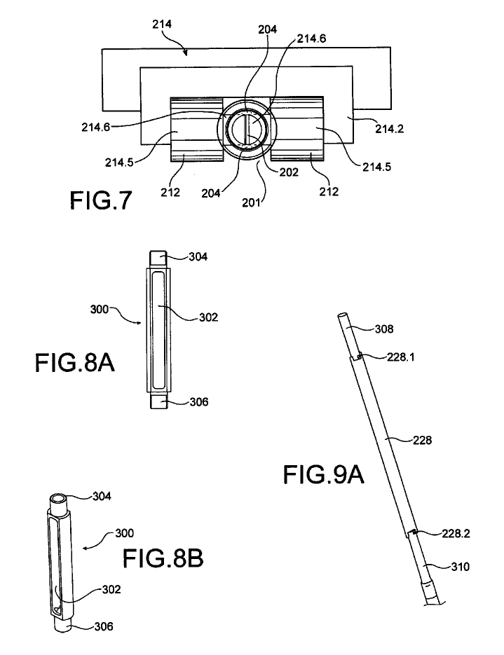

In the example shown, the means (214) comprise a magnetic circuit (214.2) of rectangular cross section (FIG. 7), a larger side of which is open, forming the space (201). The open larger side then comprises two coaxial branches (214.5) and the space (201). The means (214) comprise two solenoids (212) mounted around the branches (214.5), on either side of the space (201), with the ends (214.6) of the branches (214.5) projecting from the solenoids (212), with these ends forming magnetic poles.

In the example shown, the chamber (202) is bordered laterally on two sides directly facing the magnetic poles (214.6), and on the other two sides facing two walls such as plates (204), connecting the two magnetic poles (214.6), so as to close the periphery of the chamber.

The plates (204) are glued onto the magnetic poles for example.

In this implementation example, the magneto-rheological fluid is directly in contact with the magnetic poles (214.6). This configuration has the advantage of reducing the reluctance of the magnetic circuit. The electrical circuit of the solenoids can then have fewer turns, which reduces its time constant and renders it less bulky.

The cavity (202) is closed at first (206) and second (208) longitudinal ends, by close-off means (210, 211).

It is also possible for the end not to be closed (206), so that an opening is provided at this end (206).

The close-off means (210) shown in detail in FIG. 6, located in the example shown on the upper part of the device (in which case, it is not strictly necessary for the operation of the simulator), comprises a tubular element (216) that is attached in a sealed manner by one of its axial ends (216.1) to a top end (214.7) of the magnetic poles (214.6). The tubular element (216) has an inside diameter that is greater than a larger transverse dimension of the cavity (202) and an outside diameter that is less than the width of the space (201).

The tubular element (216) is glued onto the magnetic poles (214.6) for example.

A cap (217) closes off, in a sealed manner, another axial end (216.2) of the tubular element (216), by screwing onto the latter for example.

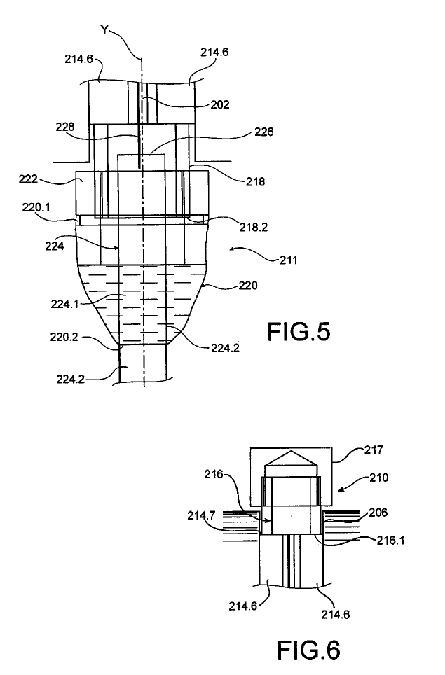

The second close-off means (211), shown in detail in FIG. 5, closes off a bottom end of the cavity (202), through which will enter an element attached to a control component, which in our example is a keyboard key, designed to shear the magneto-rheological fluid. In this embodiment, it consists of a blade (228).

In an advantageous manner, the blade (228) is of relatively small longitudinal dimension so as to limit the risks of buckling, and is connected to the key by a blade support (224) which presents no risk of buckling at the scale of the forces involved here.

The blade (228) is advantageously flexible in order to convert the rotary movement of the key into a movement in translation of the mobile element in the magnetic gap between the magnetic poles.

The blade (228) can be made from nonmagnetic material, from brass for example, or from copper or mica.

This second close-off means (211) comprises a tubular element (218) of similar dimension to that of the tubular element (216), attached by one face (218.1) to the magnetic poles (214.6).

A second face (218.2) of the tubular element (218) is closed off by a partially unrolling flexible membrane (220).

The flexible membrane (220) can also be of more-or-less tubular or tapered shape.

The membrane (220) which forms a seal to the magneto-rheological fluid, is attached, by a first end (220.1), of a fixed ring (222), in a sealed manner, onto the tubular element (216) on the side of the face (218.2), by screwing for example and, by a second end (220.2) to the blade support (224).

In the example shown, the blade support (224) consists of a rod in two parts, which will be described later.

The membrane (220) can be glued onto the ring (222) or created as a single part with the ring (222), by simultaneous moulding for example.

The rod comprises a first part (224.1) inside the chamber (202) and a second part (224.2) outside the chamber (202), with the second end (220.2) of the membrane (220) being pinched, in a sealed manner, between the two parts (224.1, 224.2) of the rod. The two parts (224.1, 224.2) of the rod can be attached to each other by screwing, glueing or any other means of attachment.

In the example shown, the blade penetrates into the cavity via the bottom of the latter, but it can also be arranged that the blade (228) penetrates into the cavity via the top, allowing complete incorporation below the key of the piano.

The rod (224) is mobile in translation along the Y axis of the cavity (202) and can move without damaging the seal of the cavity (202), by virtue of the membrane (220).

A first longitudinal end (not shown) of the rod (224) is connected to a control component, which in the current example is the keyboard key, and a second longitudinal end (226) of the rod carries the blade (228), which is designed to move along the X axis in the space (201) between the two magnetic poles (214.6).

The use of a composite rod as the blade support results in eliminating the risks of buckling, and facilitates the sealed attachment of the unrolling membrane (220).

The chamber (202) is then formed by the space between the magnetic poles (214.6) and the membrane (220), and the magneto-rheological fluid fills the space between the magnetic poles (214.6) and the membrane (220).

Force and/or movement sensors are also provided in order to measure the force applied to the key and/or its movement.

These sensors can be placed directly on the key, the blade (228) or the rod (224).

These sensors are linked to a control unit (FIG. 11) that generates, in real time, a variable electric current that allows the means (214) to produce a suitable magnetic field. Calculation of the magnetic field is accomplished using the data from the sensors and from a mathematical model of the behaviour to be simulated, and which is pre-recorded in the memory of the control component (700).

When the mobile element is nonmagnetic, its thickness is preferably as small as possible in order to minimise the reluctance of the magnetic circuit, which then reduces the electrical power required.

Other means for sealing the chamber (202) can be provided, such as an o-ring, lip seal, packing gland, etc. The partially unrolling membrane system has the advantage of providing a very low mechanical resistance to the advance of the manual control component, without the need for an auxiliary active device.

The means to return the rod to the rest position can also be provided, such as a spring, an added mass (according to the arrangement of the simulator), an electromagnet, etc.

In one implementation example, the magnetic circuit can have a length of between 50 mm and 70 mm, a width of between 18 mm and 27 mm and a height of 70 mm. The thickness of the magnetic gap can be 1 mm. The blade has a thickness of 0.2 mm, a width of 6.8 mm and a height of 85 mm for example. As to the chamber, it has a width of 7 mm and a height of 105 mm.

The total height of the device is then 140 mm, which renders it suitable for installation in particular under the key of a keyboard on an electric piano.

The operation of the simulation device will now be described.

The operation described previously in relation to FIG. 11 applies here also.

When the musician presses down on the key, the force applied to the key and/or the movement of the key are measured and transmitted to the control unit, typically at a sampling frequency of 2 kHz.

In accordance with these measurements, and with the dynamic model of the device to be simulated, the control component determines, in real time, the magnetic field to be applied, and generates the appropriate current in the means (214) for the generation of a magnetic field.

The fluid then experiences a change in its apparent viscosity, and the shearing of the fluid caused by the movement of the blade (112) is then rendered more difficult or less difficult. A variable resistance, simulating the sensation of a traditional keyboard, of a piano for example, is thus felt by the musician throughout the action of pressing the key.

When the musician releases the pressure on the key, the latter is brought back into the rest position by return means (not shown). Zero magnetic induction is then applied to the magneto-rheological fluid in order to facilitate the return of the blade to its rest position.

According to this present invention, the movement of the key and/or the force applied to it are measured during the whole period of application of the force, in order to modulate the magnetic field during movement of the key, and to reproduce, as closely as possible, the touch sensation of a traditional keyboard.

According to a very advantageous variant of the second embodiment of the invention, represented in FIG. 8, the chamber (302) is bordered by an element (300) that is added as a single part, produced by machining or by moulding for example.

This element (300) is of extended shape, and comprises two lateral openings (302), facing each other in this present example, which are intended to be closed off by the magnetic poles (214.6).

The element (300) also comprises a first (304) and a second (306) longitudinal open end, opening out between the openings (302) of element 300.

As for the example of achievement shown in FIGS. 3 and 4, the cap (217) is screwed onto the first longitudinal end (304) of the element (300) and the ring (222) forming the membrane support is screwed onto the second longitudinal end (306) of element 300.

This element advantageously results in a better seal due to the reduction in the number of parts employed.

As described previously, it is also possible for the end not to be closed (210).

In a variant of achievement, the blade (228) penetrating into the magneto-rheological fluid is made from a magnetic material. The advantage is that the method of interaction with the magneto-rheological fluid is more effective, so as to maximise the force applied for a given electrical circuit. In this case, it is preferable that the blade should be guided laterally during its movement in order to prevent any adhesion to either of the magnetic poles.

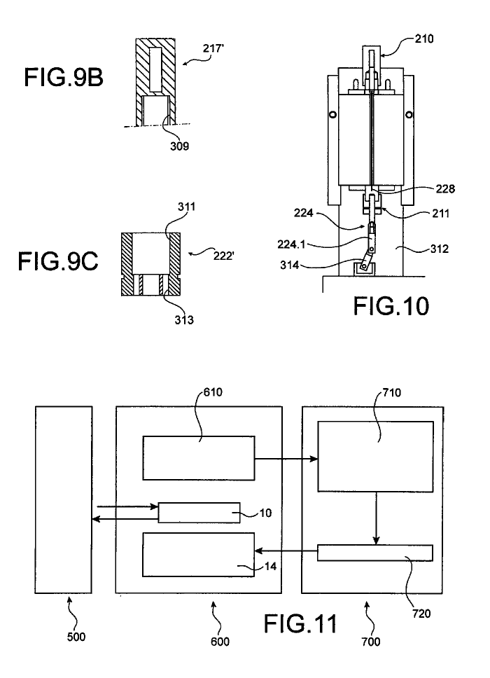

FIG. 9A shows an example of such guidance. At each of its longitudinal ends (228.1, 228.2), the blade (228) comprises an extension (308, 310) of circular section that is intended to enter into bores (309, 311) made at the ends of the chamber (202), one of which is closes off by the cap (217′) and the other is made in the ring (222′), representations of which can be seen in FIGS. 9B and 9C.

In FIG. 9B, we can see the cap (217′), seen in section with the bore (309) adjusted to the diameter of the extension (308).

In FIG. 9C, we can see the ring (222′), here in section, with the bore (310) adjusted to the diameter of the extension (310), surrounded by channels (313) in order to allow the passage of the magneto-rheological fluid.

Thus the extensions (308, 310) slide in the ends of the chamber (202), longitudinally guiding the movement of the blade in the chamber (202), thus eliminating any risk of adhesion of the blade onto one of the poles.

A device in which the blade comprises such guidance means, but where the blade is not made from a magnetic material, nevertheless is not considered to be outside the scope of this present invention.

It can also be arranged advantageously to replace the blade by a set of blades mounted as a comb and mobile in relation to another comb of blades mounted in a fixed manner on one of the poles, and used to increase the area of interaction with the magneto-rheological fluid.

FIG. 10 shows a device according to a variant of a second embodiment, allowing a transformation from a rotary movement of the manual control component, such as in the example of application of the musical keyboard, into a movement of the blade in translation.

According to the variant of achievement represented in FIG. 10, the device comprises a rotating slider crank mechanism (312) connecting the manual control component to the blade.

The crank and connecting rod (312) is of a known type, and comprises two arms connected in rotation by one of their ends, with one (314) connected in rotation to the control component by another end, and the other arm formed by the second part (224.1) of rod 224.

The transformation from the rotary movement into a movement in translation can also be achieved by means of another known system, such as a rack and pinion system for example.

The link between the manual control component and the mobile element interacting with the magneto-rheological fluid is thus improved.

This present invention applies in particular to digital pianos, but it also applies to all manual control systems that require a counter-reaction in order to allow control over the force.

This present invention can apply to any device with variable force feedback, such as a man-machine interface, other than the keys of a musical keyboard, comprising a pedal, in a vehicle or other, a joystick, a haptic device for the creation of virtual reality or remote-operation (surgical or in a hostile environment, for example).

1. A chromatic keyboard musical instrument equipped with twelve keys per octave, of the piano type with at least one tactile or haptic sensory simulation device associated with at least one of said keys, where said device is intended to oppose the movement of said key with a reaction reflecting the operation of the control, where said device has a chamber containing a magneto-rheological fluid, at least one mobile element designed to shear the magneto-rheological fluid and intended to be linked mechanically to said key, where said element has at least one blade designed to shear the magneto-rheological fluid, with said element being mobile between two predetermined positions, at least one sensor with a high cinematic or dynamic range that is representative of the movement of this element or of the control component, and a control component and a generator of a suitable magnetic field around the chamber, with said sensor being linked to the control component, which itself is linked to the generator of a magnetic field, the whole being such that the apparent viscosity of the magneto-rheological fluid varied during movement of said key.

2. A musical instrument according to claim 1, wherein the control component is designed to receive, in real time, measurements coming from at least one sensor, and to calculate the current to be applied to the generator of a suitable magnetic field as a function of time, firstly from a dynamic model of the instrument to be simulated, and secondly from the real-time measurements coming from said sensor.

3. A musical instrument according to claim 1, wherein the sensor is chosen between a force sensor applied to or by said key, and a sensor of movement of the manual control component or of the mobile element.

4. A musical instrument according to claim 1, wherein the mobile element comprises several blades combined into two groups called combs, one being mobile in relation to the other, so as to increase the area of fluid subjected to shear.

5. A musical instrument according to claim 1, wherein the mobile element is made from a nonmagnetic material such as brass, copper or mica.

6. A musical instrument according to claim 1, wherein the mobile element is made from a magnetic material such as iron or steel, and comprises guidance means made from a nonmagnetic material.

7. A musical instrument according to claim 1, wherein the mobile element is flexible.

8. A musical instrument according to claim 1, wherein the chamber comprises a flexible pocket containing a magneto-rheological fluid, with said pocket being sandwiched between a pole of the generator of a suitable field and the blade, where said blade is in more-or-less flat contact with an outer envelope of the pocket.

9. A musical instrument according to claim 1, wherein the chamber comprises several flexible pockets containing a magneto-rheological fluid, said pockets being sandwiched between a pole of the generator of a suitable field and the blade, where said blade is in more-or-less flat contact with the outer envelopes of the pockets.

10. A musical instrument according to claim 1, wherein the blade penetrates into the magneto-rheological fluid.

11. A musical instrument according to claim 10, where a blade support has a resistance to buckling that is greater than that of the blade, designed to connect the blade to the manual control component.

12. A musical instrument according to claim 11, wherein the blade support comprises a rod in two parts, namely a first part positioned in the chamber and a second part positioned outside the chamber, with a flexible membrane, closing off one end of the chamber in a sealed manner, being pinched between the two parts of the rod.

13. A musical instrument according to claim 1, with means for returning the manual control component to the rest position.

14. A musical instrument according to claim 1, wherein the generator of a suitable magnetic field comprises at least one solenoid and a core on either side of the chamber.

15. A musical instrument according to claim 1, wherein the generator of a suitable magnetic field comprises at least one solenoid.

16. A musical instrument according to claim 14, wherein the blade penetrates into the magneto-rheological fluid and wherein the chamber is bordered laterally and directly by the generator of a suitable magnetic field, and by plates or shells, where the magneto-rheological fluid comes into direct contact with the generator of a suitable magnetic field, and wherein the chamber is bordered longitudinally at a first end by a flexible membrane and equipped at a second end with a cap, a flexible membrane or an opening.

17. A musical instrument according to claim 15, wherein the blade penetrates into the magneto-rheological fluid and wherein the chamber is bordered laterally and directly by the generator of a suitable magnetic field, and by plates or shells, where the magneto-rheological fluid comes into direct contact with the generator of a suitable magnetic field, and wherein the chamber is bordered longitudinally at a first end by a flexible membrane and equipped at a second end with a cap, a flexible membrane or an opening.

18. A musical instrument according to claim 14, wherein the blade penetrates into the magneto-rheological fluid and wherein the chamber is bordered laterally and directly by an element added as a single part, with lateral openings and closed off by the generator of a suitable magnetic field, where the magneto-rheological fluid comes into direct contact with the generator of a suitable magnetic field, and wherein the chamber is bordered longitudinally at a first end by a flexible membrane, and equipped at a second end with a cap, a flexible membrane or an opening.

19. A musical instrument according to claim 15, wherein the blade penetrates into the magneto-rheological fluid and wherein the chamber is bordered laterally and directly by an element added as a single part, with lateral openings and closed off by the generator of a suitable magnetic field, where the magneto-rheological fluid comes into direct contact with the generator of a suitable magnetic field, and wherein the chamber is bordered longitudinally at a first end by a flexible membrane, and equipped at a second end with a cap, a flexible membrane or an opening.
